(19) United States
(12) Patent Application Publication
(10) Pub. No.: US 2026/0065776 A1
(43) Pub. Date: Mar. 5, 2026

(54) Vehicle Communications Using a Light Signal Network

(71) Applicant: International Business Machines Corporation, Armonk, NY (US)

(72) Inventors: Guang Han Sui, Beijing (CN); Peng Hui Jiang, Beijing (CN); Su Liu, Austin, TX (US); Jun Su, Beijing (CN); Yu Zhu, Beijing (CN); Jun Feng Duan, Beijing (CN)

(21) Appl. No.: 18/818,963

(22) Filed: Aug. 29, 2024

(51) Int. Cl. G08G 1/0967; H04B 10/116

(52) U.S. Cl. CPC G08G 1/096783; H04B 10/116

(57) ABSTRACT

A computer implemented method provides vehicle to vehicle communications. Vehicle light signals encoding traffic information are received from a source vehicle travelling on a road at a light signal device in a light signal network. The traffic information encoded in the vehicle light signals are stored to form stored traffic information. Transmission light signals encoding the stored traffic information are transmitted from the light signal network to a receiver vehicle in response to detecting the receiver vehicle traveling along the road. According to other illustrative embodiments, a computer system and a computer program product for vehicle to vehicle communications are provided.

### BACKGROUND

The disclosure relates generally to an improved communications system and more specifically to vehicle communications on roads.

Vehicle communication for vehicles on a road involves the exchange of information between the vehicles. This exchange of information is facilitated using a vehicle communications network. In this network, vehicles and roadside devices are communications nodes that communicate with each other to exchange information. This exchange of information can improve safety and traffic management. This exchange can also be used to provide infotainment.

Vehicles can communicate directly with each other. This type of communication is called vehicle to vehicle (V2V) communications. In other cases, information can be between vehicles and roadside infrastructure. This type of communication is referred to as vehicle to infrastructure (V2I) communications. Information that can be communicated using these types of communications in a vehicle communications network can include images, speed of vehicles, temperatures of the environment around the vehicles, road hazards, and other information.

### SUMMARY

According to one illustrative embodiment, a computer implemented method provides vehicle to vehicle communications. Vehicle light signals encoding traffic information are received from a source vehicle travelling on a road at a light signal device in a light signal network. The traffic information encoded in the vehicle light signals are stored to form stored traffic information. Transmission light signals encoding the stored traffic information are transmitted from the light signal network to a receiver vehicle in response to detecting the receiver vehicle traveling along the road. According to other illustrative embodiments, a computer system and a computer program product for vehicle to vehicle communications are provided.

### BRIEF DESCRIPTION OF THE DRAWINGS

FIG. 1 is a block diagram of a computing environment in accordance with an illustrative embodiment;

FIG. 2 is a block diagram of a traffic environment in accordance with an illustrative embodiment;

FIG. 3 is an illustration of transmitting traffic information using a light signal network in accordance with an illustrative embodiment;

FIG. 4 is an illustration of transmitting traffic information to a vehicle in accordance with an illustrative embodiment;

FIG. 5 is an illustration of transmitting traffic information to a vehicle in accordance with an illustrative embodiment;

FIG. 6 is a flowchart of a process for processing traffic information using a light signal device in accordance with an illustrative embodiment;

FIG. 7 is a flowchart of a process for processing traffic information using a vehicle in accordance with an illustrative embodiment;

FIG. 8 is a flowchart of a process for people to vehicle communications in accordance with an illustrative embodiment;

FIG. 9 is a flowchart of a process for storing traffic information in accordance with an illustrative environment;

FIG. 10 is a flowchart of a process for transmitting transmission light signals in accordance with an illustrative embodiment;

FIG. 11 is a flowchart of a process for transmitting transmission light signals in accordance with an illustrative embodiment;

FIG. 12 is a flowchart of a process for updating stored traffic information in accordance with an illustrative embodiment;

FIG. 13 is a flowchart of a process for managing stored traffic information in accordance with an illustrative embodiment;

FIG. 14 is a flowchart of a process for transmitting stored traffic information in accordance with an illustrative embodiment; and

FIG. 15 is a block diagram of a data processing system in accordance with an illustrative embodiment.

### DETAILED DESCRIPTION

A computer implemented method provides vehicle to vehicle communications. Vehicle light signals encoding traffic information are received from a source vehicle travelling on a road at a light signal device in a light signal network. The traffic information encoded in the vehicle light signals is stored to form stored traffic information. Transmission light signals encoding the stored traffic information are transmitted from the light signal network to a receiver vehicle in response to detecting the receiver vehicle traveling along the road. As a result, the illustrative embodiments provide a technical effect of providing for the exchange of traffic information between vehicles using light signals.

Further, as part of storing the traffic information, the traffic information is processed to determine traffic conditions relating to the road and the traffic conditions are stored to form the stored traffic information. As a result, the illustrative embodiments provide a technical effect of an ability to store the traffic conditions for later transmission.

Additionally, as part of transmitting the transmission light signals, the transmission light signals encoding the stored traffic information are transmitted from the light signal device in response to the light signal device detecting the receiver vehicle traveling on the road. As a result, the illustrative embodiments provide a technical effect of transmitting the stored traffic information from the light signal device to the receiver vehicle.

Also, as part of transmitting transmitted light signals, the transmission light signals encoding the stored traffic information are transmitted from another light signal device along the road in response to the another light signal device detecting the receiver vehicle traveling on the road. As a result, the illustrative embodiments provide a technical effect of transmitting the stored traffic information from another light signal device.

In addition, the stored traffic information is for a selected traffic condition and the stored traffic information is updated in response to receiving updated traffic information for the selected traffic condition. As a result, the illustrative embodiments provide a technical effect of updating stored traffic information.

Furthermore, the stored traffic information is for a selected traffic condition and an expiration time is identified for the selected traffic condition. The stored traffic information for the selected traffic condition is discarded in response to an absence of receiving an update to the stored traffic information for the selected traffic condition within the expiration time. As a result, the illustrative embodiments provide a technical effect of discarding stored traffic information for a selected component in response to an absence of receiving an update to the stored traffic information for the selected traffic condition within the expiration time.

Also, the stored traffic information is transmitted from the light signal device to a second light signal device that is located along the road upstream from the light signal device. The stored traffic information is transmitted in the transmission light signals encoding the stored traffic information from the second light signal device to a second receiver vehicle in response to the second light signal device detecting the second receiver vehicle on the road. As a result, the illustrative embodiments provide a technical effect of transmitting the stored traffic information to the second light signal device to transmit to the second receiver vehicle.

Further, the light signal device is connected to a platform selected from a group comprising a road light, a light signal, a road sign, a post, a guard rail, a bridge, and an overpass. As a result, the illustrative embodiments provide a technical effect of connecting a light signal device to a platform.

Also, the light signal network is selected from a group comprising a LiFi network and an optical network. As a result, the illustrative embodiments provide a technical effect of using a light signal network in the form of a LiFi network and an optical network.

A computer system comprises a processor set of one or more computer-readable storage media and program instructions, collectively stored in the set of one or more storage media to cause the processor set to perform operations. The computer system receives vehicle light signals encoding traffic information from a source vehicle travelling on a road at a light signal device in a light signal network. The computer system stores the traffic information encoded in the vehicle light signals to form stored traffic information. The computer system transmits transmission light signals encoding the stored traffic information from the light signal network to a receiver vehicle in response to detecting the receiver vehicle traveling along the road. As a result, the illustrative embodiments provide a technical effect of providing for the exchange of traffic information between vehicles using light signals.

Also, as part of the traffic information, the computer system processes the traffic information to determine traffic conditions relating to the road and stores the traffic conditions to form the stored traffic information. As a result, the illustrative embodiments provide a technical effect of an ability to store the traffic conditions for later transmission.

Further, as part of transmitting the transmission light signals, the computer system transmits the transmission light signals encoding the stored traffic information from the light signal device in response to the light signal device detecting the receiver vehicle traveling on the road. As a result, the illustrative embodiments provide a technical effect of transmitting the stored traffic information from the light signal device to the receiver vehicle.

Additionally, as part of transmitting transmitted light signals, the computer system transmits the transmission light signals encoding the stored traffic information from another light signal device along the road in response to the another light signal device detecting the receiver vehicle traveling on the road. As a result, the illustrative embodiments provide a technical effect of transmitting the stored traffic information from another light signal device.

Furthermore, the stored traffic information is for a selected traffic condition. The computer system updates the stored traffic information in response to receiving updated traffic information for the selected traffic condition. As a result, the illustrative embodiments provide a technical effect of updating stored traffic information.

In addition, the stored traffic information is for a selected traffic condition. The computer system identifies an expiration time for the selected traffic condition. The computer system discards the stored traffic information for the selected traffic condition in response to an absence of receiving an update to the stored traffic information for the selected traffic condition within the expiration time. As a result, the illustrative embodiments provide a technical effect of discarding stored traffic information for a selected component in response to an absence of receiving an update to the stored traffic information for the selected traffic condition within the expiration time.

Further, the computer system transmits the stored traffic information from the light signal device to a second light signal device that is located along the road upstream from the light signal device. The computer system transmits the stored traffic information in the transmission light signals encoding the stored traffic information from the second light signal device to a second receiver vehicle in response to the second light signal device detecting the second receiver vehicle on the road. As a result, the illustrative embodiments provide a technical effect of transmitting the stored traffic information to the second light signal device to transmit to a second receiver vehicle.

Also, the light signal device is connected to a platform selected from a group comprising a road light, a light signal, and a road sign. As a result, the illustrative embodiments provide a technical effect of connecting a light signal device to a platform.

Further, the light signal network is selected from a group comprising a LiFi network and an optical network. As a result, the illustrative embodiments provide a technical effect of using a light signal network in the form of a LiFi network and an optical network.

A computer program product provides vehicle to vehicle communications. The computer program product comprises a set of one or more computer-readable storage media.

Program instructions are stored on the set of one or more storage media to perform operations. The operations include receiving vehicle light signals encoding traffic information from a source vehicle travelling on a road at a light signal device in a light signal network. The operations comprise storing the traffic information encoded in the vehicle light signals to form stored traffic information. The operations comprise transmitting transmission light signals encoding the stored traffic information from the light signal network to a receiver vehicle in response to detecting the receiver vehicle traveling along the road. As a result, the illustrative embodiments provide a technical effect of providing for the exchange of traffic information between vehicles using light signals.

Also, as part of storing the traffic information, the traffic information is processed to determine traffic conditions relating to the road. The traffic conditions are stored to form the stored traffic information. As a result, the illustrative embodiments provide a technical effect of an ability to store the traffic conditions for later transmission.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

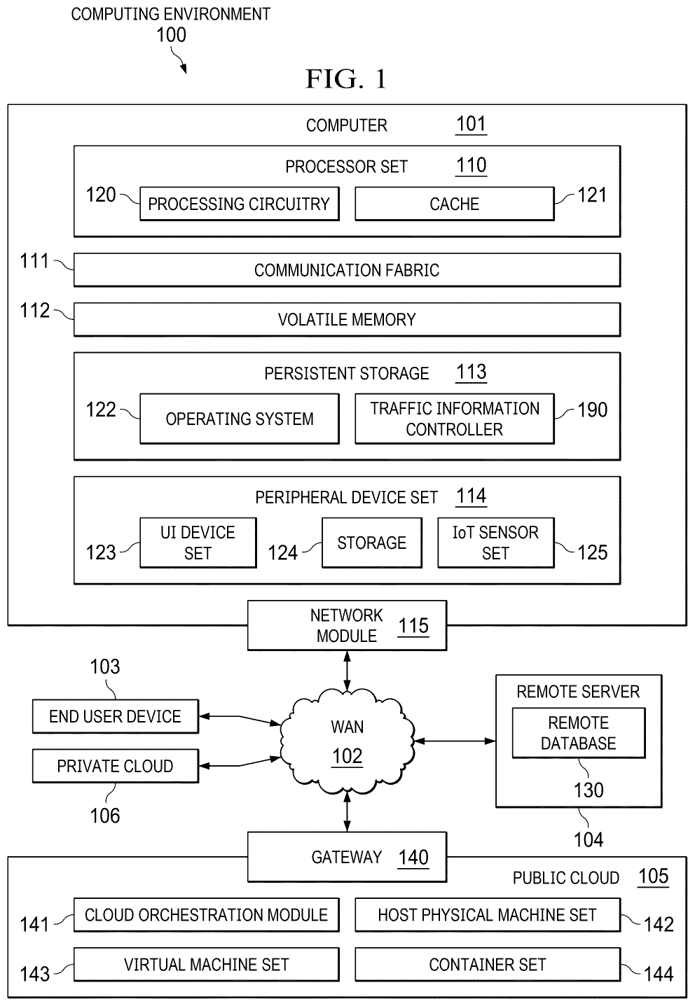

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as traffic information controller 190. In addition to traffic information controller 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and traffic information controller 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in traffic information controller 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices.

Operating system 122 may take several forms, such as various known proprietary operating systems or open source Portable Operating System Interface-type operating systems that employ a kernel. The code included in traffic information controller 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. Vehicles generate information about the environment around them as well as information about the vehicles while driving on a road. Sharing this information with other vehicles that may pass the same location on the road a few minutes later can be challenging. For example, this information can be uploaded to navigation application on the Internet that analyzes and identifies traffic conditions. Other vehicles can download this information onto their local navigation programs. However, this information may not be provided in real time. Further, this application provides a high load on the Internet.

In some cases, vehicles can exchange information directly. However, these solutions do not work for vehicles that cannot communicate directly. For example, a vehicle passing a location on the road several minutes later cannot directly communicate with the prior vehicle that previously passed the location and generated information about the location.

Thus, the illustrative examples provide a computer implemented method, apparatus, computer system, and computer program product for vehicle to vehicle communications. In one illustrative example, a computer implemented method provides the vehicle to vehicle communications. Vehicle light signals encoding traffic information are received from a source vehicle travelling on a road at a light signal device in a light signal network. The traffic information encoded in the vehicle light signals is stored to form stored traffic information. Transmission light signals encoding the stored traffic information are transmitted from the light signal network to a receiver vehicle in response to detecting the receiver vehicle traveling along the road.

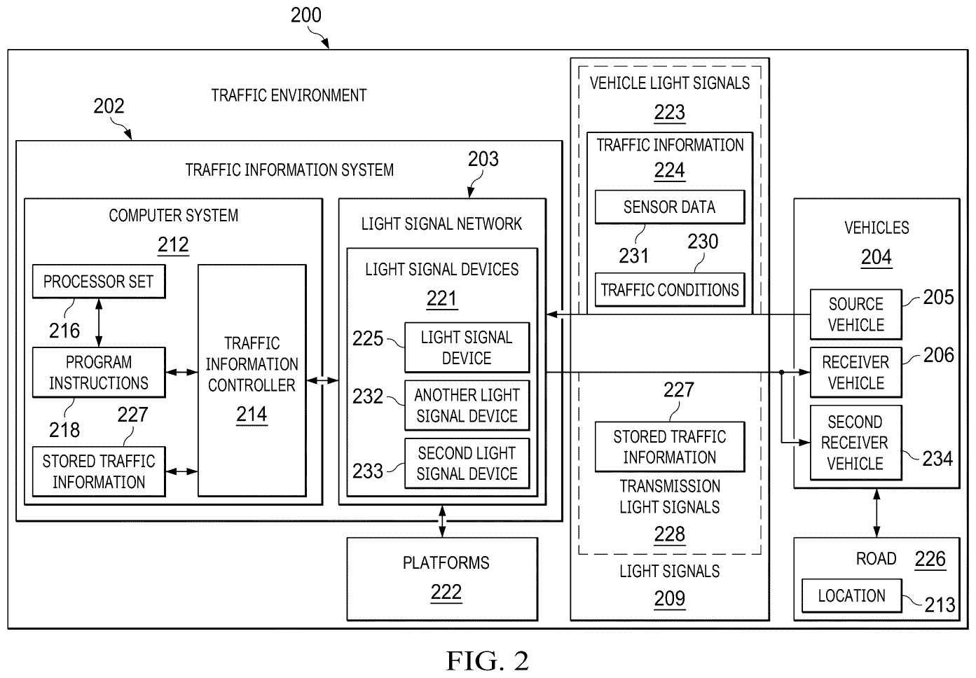

With reference now to FIG. 2, a block diagram of a traffic environment is depicted in accordance with an illustrative embodiment. In this illustrative example, traffic environment 200 includes components that can be implemented in hardware such as the hardware shown in computing environment 100 in FIG. 1. In this example, traffic information system 202 can operate to facilitate the exchange of traffic information 224 between vehicles 204. Vehicles 204 can take a number of different forms. For example, vehicles 204 can be selected from at least one of a car, a motorcycle, a bus, an ambulance, a van, a SUV, a sports car, a truck, a semi-trailer truck, and other types of vehicles that travel on roads. Traffic information controller 214 can be implemented using traffic information controller 190 in FIG. 1.

In this illustrative example, traffic information system 202 is comprised of a number of different components. As depicted, traffic information system 202 comprises computer system 212, traffic information controller 214, and light signal network 203. Traffic information controller 214 is located in computer system 212.

In this example, light signal network 203 comprises infrastructure used to facilitate the transfer of traffic information. Light signal network 203 can be, for example, selected from a group comprising a light fidelity (LiFi) network and an optical network. A light fidelity network is a communications technology that uses light to transmit data and position between devices.

In this illustrative example, light signal network 203 comprises light signal devices 221. Light signal devices 221 can be selected from at least one of a receiver, a transmitter, or a transceiver. A receiver is a hardware device that can receive optical signals. For example, a receiver can be a camera, a photo detector, or some other suitable device. A transmitter is a hardware device that can transmit optical signals. The transmitter can be, for example, a light emitting diode, a laser beam, an infrared light, or some other suitable transmitter. A transceiver is a hardware device that can include receive and transmit optical signals and can be comprised of combinations of the different types of devices used in the receiver and transmitter.

In this illustrative example, light signal devices 221 are connected to platforms 222. Platforms 222 can be selected from at least one of a road light, a light signal, a roadside, a post, a guardrail, a bridge, an overpass, or other types of platforms to which light signal devices 221 can be connected or otherwise attached.

In this example, traffic information controller 214 can be implemented in software, hardware, firmware or a combination thereof. When software is used, the operations performed by traffic information controller 214 can be implemented in program instructions configured to run on hardware, such as a processor unit. When firmware is used, the operations performed by traffic information controller 214 can be implemented in program instructions and data and stored in persistent memory to run on a processor unit. When hardware is employed, the hardware can include circuits that operate to perform the operations in traffic information controller 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and a number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes processor set 216 that is capable of executing program instructions 218 implementing processes in the illustrative examples. In other words, program instructions 218 are computer-readable program instructions. Processor set 216 is an example of processor set 110 in FIG. 1.

As used herein, a processor unit in processor set 216 is a hardware device and is comprised of hardware circuits such as those on an integrated circuit that respond to and process instructions and program code that operate a computer. Processor set 216 can be a number of processor units that can be implemented using processor set 110 in FIG. 1. The processor units can also be referred to as computer processors. When processor set 216 executes program instructions 218 for a process, processor set 216 can be one or more processor units that are in the same computer or in different computers. In other words, the process can be distributed between processor units in processor set 216 on the same or different computers in computer system 212.

Further, processor set 216 can include the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

Although not shown, processor set 216 can also include other components in addition to the processor units or processing circuitry. For example, processor set 216 can also include a cache or other components used with processor units or other processing circuitry.

In this illustrative example, traffic information controller 214 can include a computer implemented method to control the operation of light signal devices 221 in processing traffic information. In the illustrative example, traffic information controller 214 is shown as a single block and can be a single component within computer system 212 that controls the operations of light signal devices 221 in light signal network 203.

In another illustrative example, traffic information controller 214 can be a distributed component in which traffic information controller 214 can be located on a portion or all of light signal devices 221. In this example, information can be transmitted between light signal network 203 and vehicles 204 using light signals 209. Light signals 209 can be any optical signal that can be modulated to encode information. The light used for light signals 209 can be selected from at least one of an infrared light, a visible light, an ultraviolet light, a laser light, or other suitable types of light. In one illustrative example, the light signals can be in the form of light fidelity (LiFi) signals that use light emitting diode (LED) light to transmit data.

In the illustrative examples, the transmissions of light signals 209 are essentially line of sight transmissions. Using light signals 209 provide for a faster exchange of information as compared to wireless signals such as radio frequency signals.

In one illustrative example, light signal device 225 in light signal devices 221 in light signal network 203 receives vehicle light signals 223 in light signals 209 that encodes traffic information 224 from source vehicle 205 in vehicles 204 when on road 226. In this example, source vehicle 205 generates traffic information 224 about location 213 on road 226, encodes this information in vehicle light signals 223, and transmits vehicle light signals 223 encoding traffic information 224.

In this example, traffic information 224 can take a number of different forms. For example, traffic information 224 can include at least one of sensor data 231 or traffic conditions 230. In this example, sensor data 231 is generated by sensors in source vehicle 205. Sensor data 231 can include at least one of an engine temperature, an environmental temperature, a fuel efficiency, a vehicle speed, a tire pressure, a tire slippage, a presence of moisture, an acceleration, a brake application, a distance to another vehicle, an object detection, an image, or other suitable information that can be generated by sensors in a vehicle.

Traffic conditions 230 can be identified using the sensor data 231 from sensors in source vehicle 205. Traffic conditions can include at least one of a road condition, a weather condition, or traffic flow. The road conditions are at least one of an obstacle on the road, debris, an oil spill, water, ice, an accident, a stalled vehicle, or other road condition. The weather conditions can be at least one of sunny weather, rain, snow, fog, or other weather conditions. Traffic flow can indicate a level of congestion including none, light, heavy, stopped, or other traffic flow.

For example, wet or icy conditions can be identified using temperatures detected by infrared sensors directed to the surface of the road 226. In another example, lidar data generated by a lidar sensor can be used to determine whether ice or water is accumulated on the road. In yet another illustrative example, a vision system can be used to analyze the surfaces of the road surface to identify visual indicators of wetness, ice, or snow.

As another example, traffic flow can be identified using sensor data 231 such as vehicle speed of source vehicle 205 or a distance to a vehicle ahead of source vehicle 205. When the vehicle speed is slower than the posted speed for road 226 and the distance to the vehicle ahead of source vehicle 205 is less than a car length for more than two minutes, the traffic flow can be identified as heavy congestion.

Traffic information controller 214 stores traffic information 224 encoded in vehicle light signals 223 to form stored traffic information 227. Traffic information controller 214 can store traffic information 224 in a number of different ways to form stored traffic information 227.

In one illustrative example, traffic information 224 can be stored with no processing or minimal processing. In this example, sensor data 231 and traffic conditions 230 in traffic information 224 can be at least one of formatted, labeled, or placed in fields in a table or database to form stored traffic information 227.

In another illustrative example, sensor data 231 in traffic information 224 can be processed to determine traffic conditions 230 related to travel on road 226. For example, sensor data 231 in traffic information 224 be analyzed to determine traffic conditions 230. These traffic conditions can be stored to form stored traffic information 227. In this example, the processing to determine traffic conditions 230 can include analyzing traffic information 224 received from source vehicle 205 to determine traffic conditions 230 around source vehicle 205 on road 226.

In this illustrative example, traffic information controller 214 transmits transmission light signals 228 in light signals 209 that encodes stored traffic information 227 from light signal network 203 to receiver vehicle 206. These transmission light signals are generated and transmitted in response to detecting the receiver vehicle 206 in vehicles 204 traveling along road 226. In this example, receiver vehicle 206 is a vehicle traveling on the road behind source vehicle 205. In this example, receiver vehicle 206 can pass location 213 previously passed by source vehicle 205.

In one illustrative example, traffic information controller 214 transmits transmission light signals 228 encoding stored traffic information 227 from light signal device 225 in response to light signal device 225 detecting the receiver vehicle 206 traveling on the road 226. In another illustrative example, traffic information controller 214 transmits transmission light signals 228 encoding stored traffic information 227 from another light signal device 232 along road 226 in response to another light signal device 232 detecting receiver vehicle 206 traveling on road 226. In this example, another light signal device 232 is in communication with light signal device 225 using light signals.

In yet another example, these two devices can be in communication with each other using a radio frequency connection if these devices do not have a line of sight to each other. This type of connection between light signal devices can be a point to point connection or can be one made using a network such as the internet.

In these illustrative examples, traffic information controller 214 manages stored traffic information 227. For example, stored traffic information 227 can be for a selected traffic condition. Traffic information controller 214 updates stored traffic information 227 in response to receiving updated traffic information for the selected traffic condition.

For example, the selected traffic condition can be a web service condition on the surface of road 226 at location 213. In this example, at 9:00 a.m., a vehicle detects a water having a depth of 2 cm. The light signals containing this information is received by light signal network 203 and saved in stored traffic information 227. At 10:00 a.m., another vehicle passing location 213 detects a water having a depth of 6 cm. Stored traffic information 227 is updated with the change in this condition. Further, in this example, at 11:00 a.m., another vehicle detects an absence of water on road 226 at location 213. The road condition becomes normal and the selected traffic condition information about water on the road can be removed from stored traffic information 227.

As another example, traffic information controller 214 can identify an expiration time for the selected traffic condition. Traffic information controller 214 can discard stored traffic information 227 for a selected traffic condition in response to an absence of receiving an update to stored traffic information 227 for the selected traffic condition within the expiration time. For example, the selected traffic condition can be traffic congestion. For example, stored traffic information 227 can include heavy congestion for the selected traffic condition. In this example, if another report of traffic is received within an expiration time, then the heavy congestion can be removed from stored traffic information 227.

The expiration time can be selected to ensure that stale traffic information is not present. The expiration time can be based on the particular traffic condition. For example, the expiration time for water on the road can be one hour while the expiration time for moderate traffic congestion can be 15 minutes. As another example, a traffic condition of an accident can have an expiration time of 90 minutes. These different times can be selected based on when different traffic conditions can be expected to change or disappear.

In the illustrative example, traffic information can be stored at the particular light signal device receiving the traffic information. With this example, the traffic information received at one light signal device can be transmitted to another light signal device for storage and transmission. For example, traffic information controller 214 can transmit stored traffic information 227 from light signal device 225 to second light signal device 233 that is located along road 226 upstream from light signal device 225. With this example, traffic information controller 214 transmits stored traffic information 227 in transmission light signals 228 encoding stored traffic information 227 from second light signal device 233 to second receiver vehicle 234 in response to second light signal device 233 detecting the second receiver vehicle 234 on road 226.

In this example, upstream means from the direction that source vehicle 205 came from. As a result, stored traffic information 227 at light signal device 225 can be sent to another vehicle that has not yet reached light signal device 225. This transmission of stored traffic information 227 increases the amount of time for another receiver vehicle to take action using stored traffic information 227.

In this example, stored traffic information 227 can be used to operate receiver vehicle 206. For example, stored traffic information 227 encoded in transmission light signals 228 can include information about traffic conditions 230 that can be used to operate receiver vehicle 206 traveling on road 226.

In another illustrative example, receiver vehicle 206 can process stored traffic information 227 to identify traffic conditions 230 that may be encountered by receiver vehicle 206 traveling through location 213 on road 226.

Traffic information system 202 with traffic information controller 214 performs steps that can be used in a practical application to operate vehicles. A practical application of this process involves receiver vehicle 206 performing a number of actions using stored traffic information 227 encoded in transmission light signals 228 received by receiver vehicle 206. For example, receiver vehicle 206 can change lanes to avoid an obstacle that may be identified in a particular lane on road 226. In another illustrative example, receiver vehicle 206 may take a detour before reaching location 213 on road 226. As another example, receiver vehicle 206 may reduce speed or be prepared to stop depending on traffic conditions 230 at location 213 on road 226.

In one illustrative example, stored traffic information transmitted through transmission light signals 228 can be displayed to a receiver vehicle 206 and the driver can operate receiver vehicle 206 using this information. In another illustrative example, receiver vehicle 206 can be an autonomous vehicle having a computer system with processes to operate receiver vehicle 206. This type of vehicle can also be referred to as a driverless car or self-driving car. In this example, receiver vehicle 206 can be an autonomous vehicle operated using a machine learning model or other artificial intelligence system.

In one illustrative example, one or more solutions are present that overcome a problem with transmitting information between vehicles. In one illustrative example, the traffic information is stored at a light signal device that can also be transmitted the traffic information to other vehicles that are detected using light signals. In this manner, the use of a network such the internet can be avoided. As another example, the light signal device can transmit information from one light signal device.

Computer system 212 can be configured to perform at least one of the steps, operations, or actions described in the different illustrative examples using software, hardware, firmware or a combination thereof. As a result, computer system 212 operates as a special purpose computer system in which traffic information controller 214 in computer system 212 enables facilitating vehicle to vehicle communications using light signals. In particular, traffic information controller 214 transforms computer system 212 into a special purpose computer system as compared to currently available general computer systems that do not have traffic information controller 214.

The illustration of traffic environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

Light signal network 203 can include other components in addition to light signal devices 221. In this example, light signal devices 221 communicate with each other using light signals. Further, in some illustrative examples light signal devices 221 can communicate using other types of signals including signals transmitted over wire connections and other types of wireless connections in addition to light signals. For example, radio frequency signals can also be used to transmit information between light signal devices 221.

In another example, stored traffic information 227 can be transmitted to vehicles traveling in the opposite direction of source vehicle 205. These vehicles may be traveling toward the location in which traffic conditions 230 have been identified for road 226.

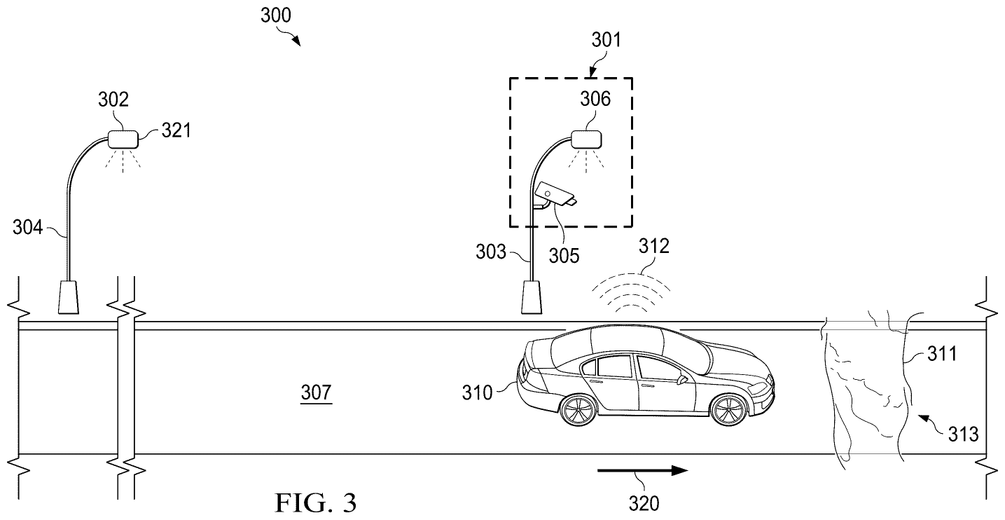

with reference next to FIG. 3, an illustration of transmitting traffic information using a light signal network is depicted in accordance with an illustrative embodiment. In this illustrative example, light fidelity (LiFi) network 300 is an example of an implementation for light signal network 203. As depicted, LiFi network 300 comprises light signal device 301 connected to light 303 and light signal device 302 connected to light 304. Light signal device 301 includes light signal receiver 305 and light signal transmitter 306. Light signal device 302 comprises light signal transmitter 321 that also functions to generate light to light road 307.

In this illustrative example, car 310 is an example of vehicles 204 in FIG. 2. As depicted, car 310 travels along road 307 in direction 320. In this example, the sensors in car 310 detect water 311 at location 313 on road 307. This water can be a safety hazard and car 310 shares this detection with other vehicles that may travel on road 307. Traffic information indicating the presence of water on road 307 at location 313 is encoded into LiFi signals 312 transmitted by car 310. In this depicted example, car 310 includes a module or other hardware device that is configured to encode traffic information and transmit LiFi signals 312.

In this example, LiFi signals 312 I are detected by light signal receiver 305 in light signal device 301. Light signal device 301 stores the traffic information about water 311 at location 313 encoded in LiFi signals 312. This information can be transmitted to other vehicles traveling on road 307 at a later time. Thus, traffic information generated by car 310 in FIG. 3 can be sent to another car without needing a line of sight or communication between car 310 in the other vehicle.

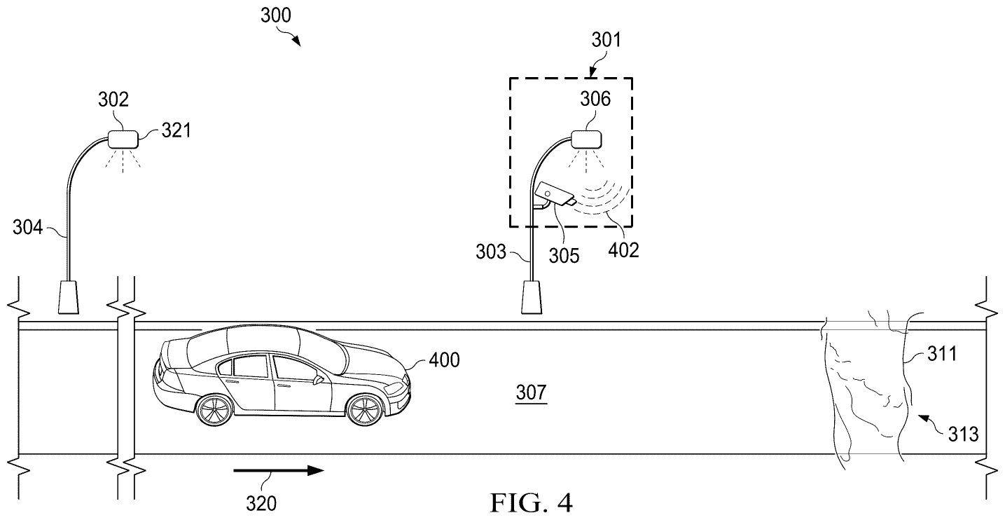

With reference now to FIG. 4, an illustration of transmitting traffic information to a vehicle is depicted in accordance with an illustrative embodiment. In this example, car 400 travels on road 307 in direction 320. Car 400 approaches water 311 at location 313 a few minutes after car 310 has passed water 311 and has transmitted traffic information about water 311 to light signal device 301. In this example, car 400 is considered to be upstream of car 310.

Light signal device 301 detects car 400 and transmits stored information about water 311 to car 400 using light signal transmitter 306 to transmit LiFi signals 402 encoding the stored information about water 311 at location 313 on road 307. In this example, car 400 receives the stored traffic information encoded in LiFi signals 402. With this information, car 400 can take appropriate action with respect to water 311. For example, car 400 can slow down prior to reaching water 311. In this manner, traffic information can be shared between vehicles more efficiently as compared to current techniques. Further, the need to upload this information to a network is also unnecessary in this example.

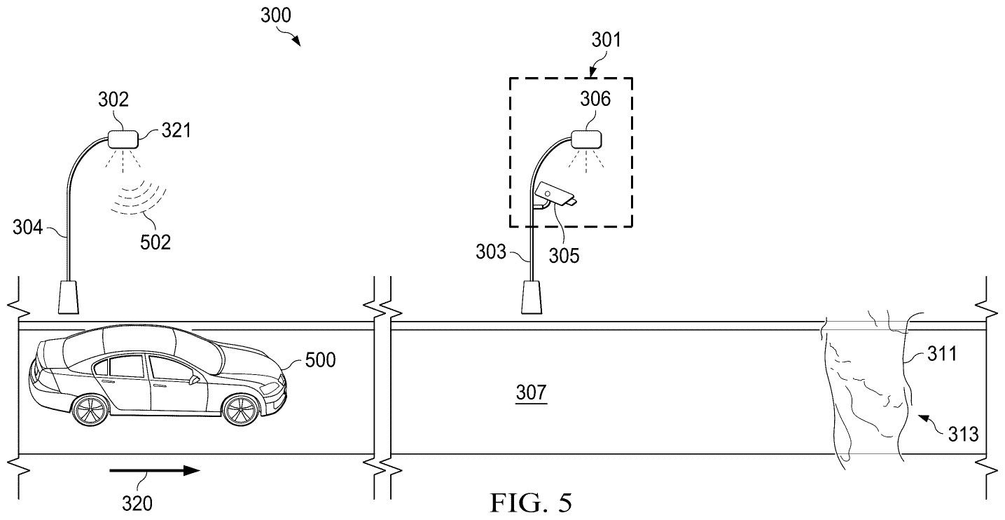

Turning now to FIG. 5, an illustration of transmitting traffic information to a vehicle is depicted in accordance with an illustrative embodiment. In this illustrative example, light signal device 302 and light signal transmitter 321 can communicate with each other using wireless signals such as radio frequency signals. As a result, these two devices do not need a line of sight to each other. Light signal device 301 transmits the stored traffic information about water 311 to light signal device 302, which is farther upstream from water 311 as compared to light signal device 301.

Light signal device 302 transmits the stored traffic information about water 311 to car 500 in Li-Fi signals emitted by light signal transmitter 321 in light signal device 302. In this manner, car 500 receives information about water 311 at location 313 sooner as compared to receiving this information from light signal device 301. As a result, additional time is provided to car 500 to take action with respect to water 311. In this example, the traffic information transmitted by light signal device 302 can also include a distance to water 311 taking into account the distance between light signal device 302 and light signal device 301. For example, the traffic information may include an indication that water 311 is 100 m ahead of car 500.

In this illustrative example, car 500 detects water 311 as car 500 reaches the location of water 311. Car 500 transmits LiFi signals to light signal device 301 encoding traffic information about water 311. This traffic information about water 311 can be used to update the stored traffic information about water 311 stored by light signal device 301. For example, the update can be that water 311 has a depth such as 2 cm. The update can be that water 311 has increased in depth to 6 cm. In another example, the update can be that water 311 is no longer present on road 307. Thus, this new traffic information can update the stored traffic information about water 311.

Further, if no updates are received after an expiration time, the traffic information about water 311 can be removed. For example, if data is not received after 3 hours, the traffic information about water 311 may be removed from light signal device 301.

Further, the traffic information received and stored by light signal device 301 can be sent to other light signal devices located along road 307 in addition to or in place of light signal device 302. The distance may be sent to light signal devices within a selected distance of water 311. This distance can be based on the usefulness of the traffic information for a particular traffic condition. For example, 100 m may be a sufficient distance for providing information about water 311 on road 307. Providing this traffic information about water 311 and greater distances may not be useful to the driver of the vehicle. As another example, a greater distance can be used for ice detected on road 307 as compared to water 311 on road 307. With ice, greater distances such as 750 m or 1000 m be used as distances to transmit information from devices to vehicles traveling on road 307. Visibility also may be used to determine the distances at which traffic information is transmitted to vehicles.

The illustration of light signal devices used to transmit traffic information in light signals in FIGS. 3-6 has been provided as an example of one implementation and not meant to limit the manner in which other illustrative examples can be implemented. For example, the light signal devices can be connected to other platforms in addition to or in place of lights. For example, these other platforms can include traffic signs, light signals, or other structures. Additionally, other types of information can be transmitted in addition to or in place of traffic information about water 311. For example, traffic congestion, obstacles on road 307, or other types of traffic information can also be transmitted in addition to or in place of information about water 311. In yet another illustrative example, light signal device 302 can also include a receiver light signal device in addition to light signal transmitter 321. In yet another illustrative example, road 307 can include multiple lanes in which vehicles can travel.

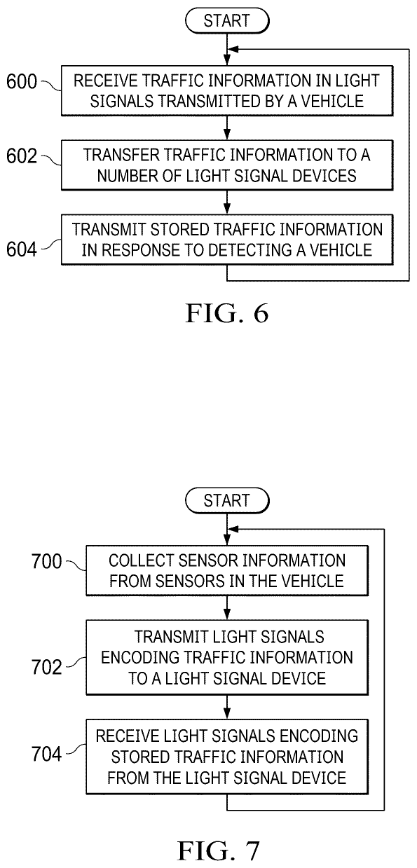

Turning next to FIG. 6, a flowchart of a process for processing traffic information using a light signal device is depicted in accordance with an illustrative embodiment. The process in FIG. 6 can be implemented in hardware, software, or both. When implemented in software, the process can take the form of program instructions that are run by a processor set located in one or more hardware devices in one or more computer systems. For example, the process can be implemented in light signal device 225 in FIG. 2.

The process begins by receiving traffic information in light signals transmitted by a vehicle (step 600). These light signals can encode traffic information for new traffic conditions or can encode traffic information that updates information for traffic conditions previously received.

The process transfers traffic information to a number of light signal devices (step 602). These additional light signal devices are considered to be nearby light signal devices when they are within a selected distance of the light signal device. The distance can be based on the usefulness of the information. Further, step 602 is an optional step in this example.

The process transmits stored traffic information in response to detecting a vehicle (step 604). The process then returns to step 600.

With reference to FIG. 7, a flowchart of a process for processing traffic information using a vehicle is depicted in accordance with an illustrative embodiment. The process in FIG. 7 can be implemented in hardware, software, or both. When implemented in software, the process can take the form of program instructions that are run by a processor set located in one or more hardware devices in one or more computer systems. For example, the process can be implemented in a vehicle in vehicles 204 such as source vehicle 205 in FIG. 2.

The process begins by collecting sensor information from sensors in the vehicle (step 700). The process transmits light signals encoding traffic information to a light signal device (step 702). In step 702, the traffic information relates to traffic conditions on the road and can include at least one of sensor information or traffic conditions. The process receives light signals encoding stored traffic information from the light signal device (704). The process returns to step 700.

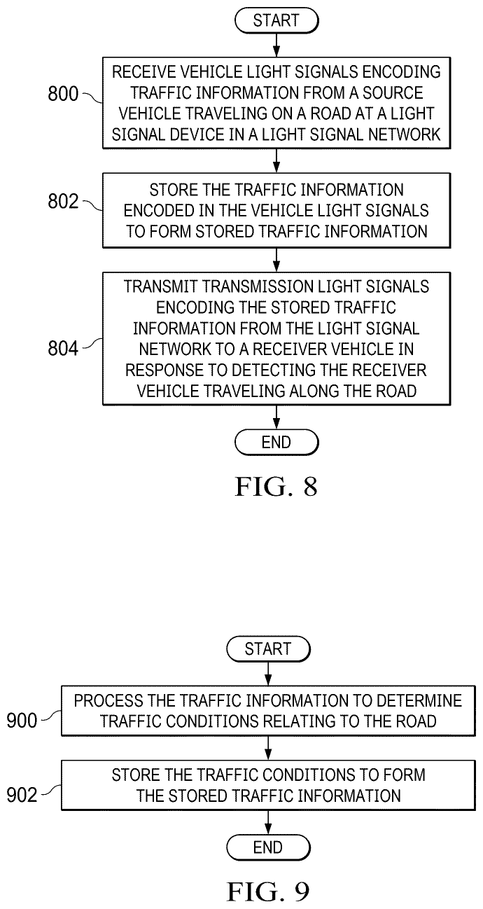

Turning now to FIG. 8, a flowchart of a process for people to vehicle communications is depicted in accordance with an illustrative embodiment. The process in FIG. 8 can be implemented in hardware, software, or both. When implemented in software, the process can take the form of program instructions that are run by a processor set located in one or more hardware devices in one or more computer systems. For example, the process can be implemented in traffic information controller 214 in computer system 212 in FIG. 2.

The process begins by receiving vehicle light signals encoding traffic information from a source vehicle travelling on a road at a light signal device in a light signal network (step 800). The process stores the traffic information encoded in the vehicle light signals to form stored traffic information (step 802).

The process transmits transmission light signals encoding the stored traffic information from the light signal network to a receiver vehicle in response to detecting the receiver vehicle traveling along the road (step 804). The process terminates thereafter.

Next in FIG. 9, a flowchart of a process for storing traffic information is depicted in accordance with an illustrative environment. The process in this flowchart is an example of step 802 in FIG. 8.

The process processes the traffic information to determine traffic conditions relating to the road (step 900). The process stores the traffic conditions to form the stored traffic information (step 902). The process terminates thereafter.

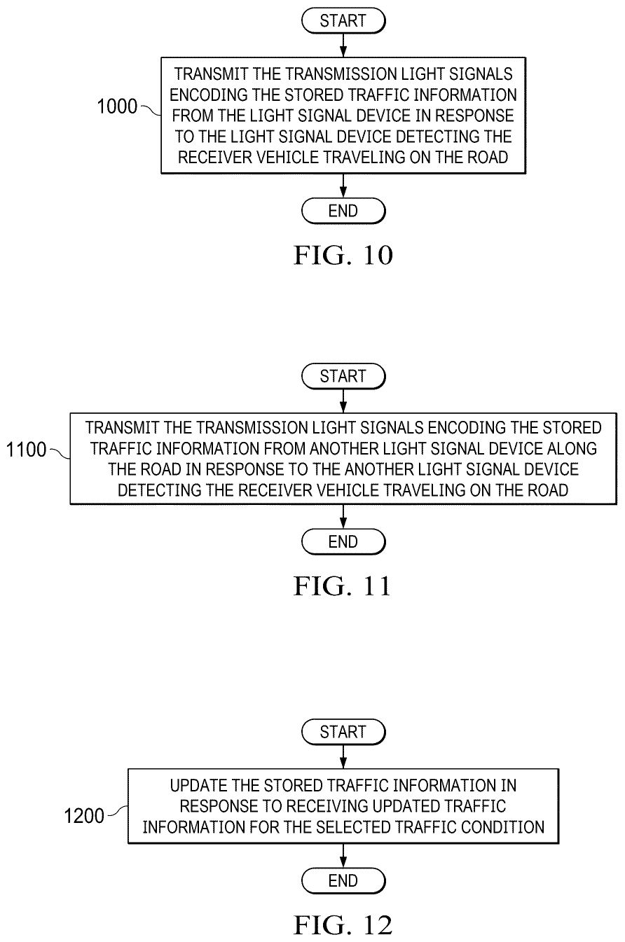

With reference now to FIG. 10, a flowchart of a process for transmitting transmission light signals is depicted in accordance with an illustrative embodiment. The process in this figure is an example of an implementation for step 804 in FIG. 8.

The process transmits the transmission light signals encoding the stored traffic information from the light signal device in response to the light signal device detecting the receiver vehicle traveling on the road (step 1000). The process terminates thereafter.

Next in FIG. 11, a flowchart of a process for transmitting transmission light signals is depicted in accordance with an illustrative embodiment. The process in this figure is an example of an implementation for step 804 in FIG. 8.

The process transmits the transmission light signals encoding the stored traffic information from another light signal device along the road in response to the another light signal device detecting the receiver vehicle traveling on the road (step 1100). The process terminates thereafter.

Turning to FIG. 12, a flowchart of a process for updating stored traffic information is depicted in accordance with an illustrative embodiment. The process in this flowchart is an example of additional steps that can be performed with the steps in FIG. 8. In this example, the stored traffic information comprises information for a selected traffic condition. The selected traffic conditions can be, for example, traffic congestion, ice on the road surface, fog, or some other traffic condition.

The process updates the stored traffic information in response to receiving updated traffic information for the selected traffic condition (step 1200). The process terminates thereafter.

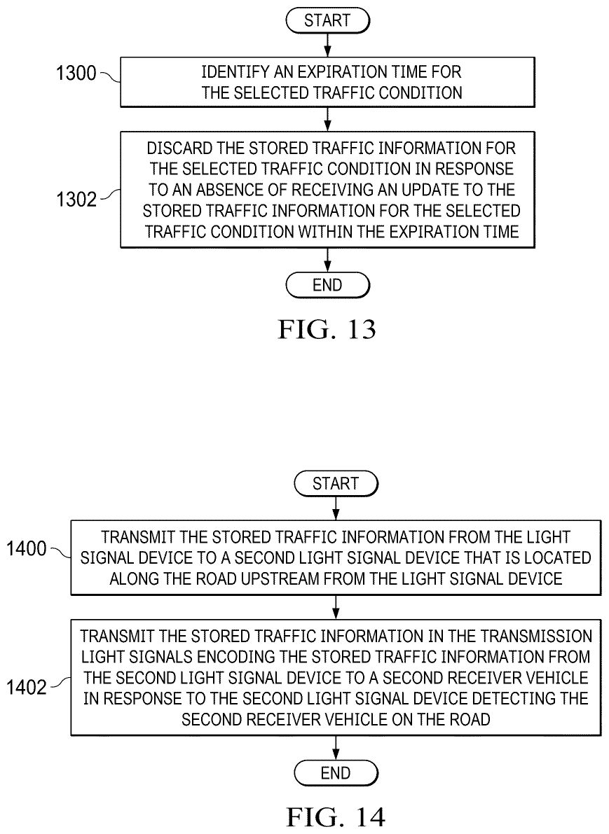

With reference now to FIG. 13, a flowchart of a process for managing stored traffic information is depicted in accordance with an illustrative embodiment. The process depicted in this flowchart is an example of additional steps that can be performed with the steps in FIG. 8. In this example, the stored traffic conditions is for a selected traffic condition.

The process identifies an expiration time for the selected traffic condition (step 1300). The process discards the stored traffic information for the selected traffic condition in response to an absence of receiving an update to the stored traffic information for the selected traffic condition within the expiration time (step 1302). The process terminates thereafter.

With reference now to FIG. 14, a flowchart of a process for transmitting stored traffic information is depicted in accordance with an illustrative embodiment. The process depicted in this flowchart is an example of additional steps that can be performed with the steps in FIG. 8.

The process transmits the stored traffic information from the light signal device to a second light signal device that is located along the road upstream from the light signal device (step 1400). The process transmits the stored traffic information in the transmission light signals encoding the stored traffic information from the second light signal device to a second receiver vehicle in response to the second light signal device detecting the second receiver vehicle on the road (step 1402). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

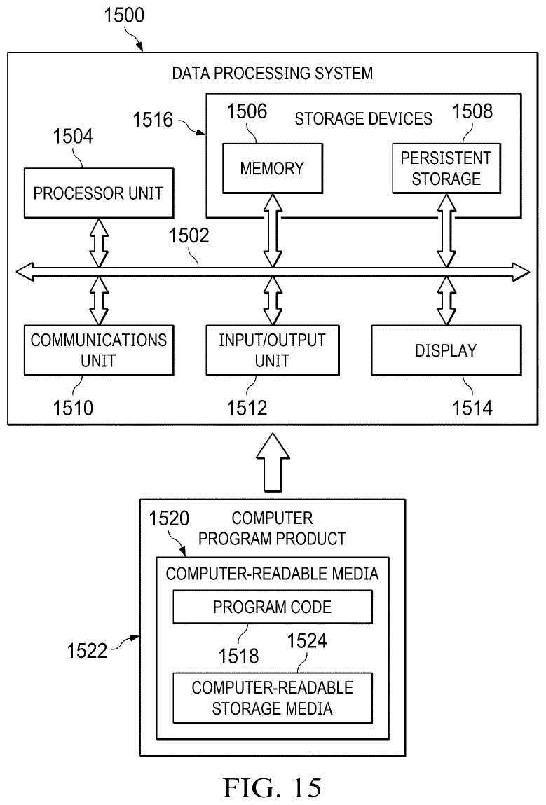

Turning now to FIG. 15, a block diagram of a data processing system is depicted in accordance with an illustrative embodiment. Data processing system 1500 can be used to implement computers and computing devices in computing environment 100 in FIG. 1. Data processing system 1500 can also be used to implement computer system 212 in FIG. 2. In this illustrative example, data processing system 1500 includes communications framework 1502, which provides communications between processor unit 1504, memory 1506, persistent storage 1508, communications unit 1510, input/output (I/O) unit 1512, and display 1514. In this example, communications framework 1502 takes the form of a bus system.

Processor unit 1504 serves to execute instructions for software that can be loaded into memory 1506. Processor unit 1504 includes one or more processors. For example, processor unit 1504 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1504 can be implemented using one or more heterogeneous processor systems in which a main processor is present with secondary processors on a single chip. As another illustrative example, processor unit 1504 can be a symmetric multi-processor system containing multiple processors of the same type on a single chip.

Memory 1506 and persistent storage 1508 are examples of storage devices 1516. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1516 may also be referred to as computer-readable storage devices in these illustrative examples. Memory 1506, in these examples, can be, for example, a random-access memory or any other suitable volatile or non-volatile storage device. Persistent storage 1508 may take various forms, depending on the particular implementation.

For example, persistent storage 1508 may contain one or more components or devices. For example, persistent storage 1508 can be a hard drive, a solid-state drive (SSD), a flash memory, a rewritable optical disk, a rewritable magnetic tape, or some combination of the above. The media used by persistent storage 1508 also can be removable. For example, a removable hard drive can be used for persistent storage 1508.

Communications unit 1510, in these illustrative examples, provides for communications with other data processing systems or devices. In these illustrative examples, communications unit 1510 is a network interface card.

Input/output unit 1512 allows for input and output of data with other devices that can be connected to data processing system 1500. For example, input/output unit 1512 may provide a connection for user input through at least one of a keyboard, a mouse, or some other suitable input device. Further, input/output unit 1512 may send output to a printer. Display 1514 provides a mechanism to display information to a user.

Instructions for at least one of the operating system, applications, or programs can be located in storage devices 1516, which are in communication with processor unit 1504 through communications framework 1502. The processes of the different embodiments can be performed by processor unit 1504 using computer-implemented instructions, which may be located in a memory, such as memory 1506.

These instructions are referred to as program instructions, computer usable program instructions, or computer-readable program instructions that can be read and executed by a processor in processor unit 1504. The program instructions in the different embodiments can be embodied on different physical or computer-readable storage media, such as memory 1506 or persistent storage 1508.

Program instructions 1518 are located in a functional form on computer-readable media 1520 that is selectively removable and can be loaded onto or transferred to data processing system 1500 for execution by processor unit 1504. Program instructions 1518 and computer-readable media 1520 form computer program product 1522 in these illustrative examples. In the illustrative example, computer-readable media 1520 is computer-readable storage media 1524.

Computer-readable storage media 1524 is a physical or tangible storage device used to store program instructions 1518 rather than a medium that propagates or transmits program instructions 1518. Computer-readable storage media 1524, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1518 can be transferred to data processing system 1500 using a computer-readable signal media. The computer-readable signal media are signals and can be, for example, a propagated data signal containing program instructions 1518. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1520” can be singular or plural. For example, program instructions 1518 can be located in computer-readable media 1520 in the form of a single storage device or system. In another example, program instructions 1518 can be located in computer-readable media 1520 that is distributed in multiple data processing systems. In other words, some instructions in program instructions 1518 can be located in one data processing system while other instructions in program instructions 1518 can be located in one data processing system. For example, a portion of program instructions 1518 can be located in computer-readable media 1520 in a server computer while another portion of program instructions 1518 can be located in computer-readable media 1520 located in a set of client computers.

The different components illustrated for data processing system 1500 are not meant to provide architectural limitations to the manner in which different embodiments can be implemented. In some illustrative examples, one or more of the components may be incorporated in or otherwise form a portion of, another component. For example, memory 1506, or portions thereof, may be incorporated in processor unit 1504 in some illustrative examples. In other examples, more than one processor unit can be present. The different illustrative embodiments can be implemented in a data processing system including components in addition to or in place of those illustrated for data processing system 1500. Other components shown in FIG. 15 can be varied from the illustrative examples shown. The different embodiments can be implemented using any hardware device or system capable of running program instructions 1518.

Thus, illustrative embodiments of the present invention provide a computer implemented method, computer system, and computer program product for vehicle to vehicle communications. In one example, a computer implemented method provides vehicle to vehicle communications. Vehicle light signals encoding traffic information are received from a source vehicle travelling on a road at a light signal device in a light signal network. The traffic information encoded in the vehicle light signals are stored to form stored traffic information. Transmission light signals encoding the stored traffic information are transmitted from the light signal network to a receiver vehicle in response to detecting the receiver vehicle traveling along the road.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for vehicle to vehicle communications, the computer implemented method comprising:
receiving vehicle light signals encoding traffic information from a source vehicle travelling on a road at a light signal device in a light signal network;
storing the traffic information encoded in the vehicle light signals to form stored traffic information; and
transmitting transmission light signals encoding the stored traffic information from the light signal network to a receiver vehicle in response to detecting the receiver vehicle traveling along the road.

2. The computer implemented method of claim 1, wherein said storing the traffic information comprises:
processing the traffic information to determine traffic conditions relating to the road; and
storing the traffic conditions to form the stored traffic information.

3. The computer implemented method of claim 1, wherein said transmitting the transmission light signals comprises:
transmitting the transmission light signals encoding the stored traffic information from the light signal device in response to the light signal device detecting the receiver vehicle traveling on the road.

4. The computer implemented method of claim 1, wherein said transmitting transmitted light signals comprises:
transmitting the transmission light signals encoding the stored traffic information from another light signal device along the road in response to the another light signal device detecting the receiver vehicle traveling on the road.

5. The computer implemented method of claim 1, wherein the stored traffic information is for a selected traffic condition and further comprising:
updating the stored traffic information in response to receiving updated traffic information for the selected traffic condition.

6. The computer implemented method of claim 1, wherein the stored traffic information is for a selected traffic condition and further comprising:
identifying an expiration time for the selected traffic condition; and discarding the stored traffic information for the selected traffic condition in response to an absence of receiving an update to the stored traffic information for the selected traffic condition within the expiration time.

7. The computer implemented method of claim 1 further comprising:
transmitting the stored traffic information from the light signal device to a second light signal device that is located along the road upstream from the light signal device; and
transmitting the stored traffic information in the transmission light signals encoding the stored traffic information from the second light signal device to a second receiver vehicle in response to the second light signal device detecting the second receiver vehicle on the road.

8. The computer implemented method of claim 1, wherein the light signal device is connected to a platform selected from a group comprising a road light, a light signal, a road sign, a post, a guard rail, a bridge, and an overpass.

9. The computer implemented method of claim 1, wherein the light signal network is selected from a group comprising a LiFi network and an optical network.

10. A computer system comprising:
a processor set;
a set of one or more computer-readable storage media; and
program instructions, collectively stored in the set of one or more storage media to cause the processor set to perform operations comprising:
receiving vehicle light signals encoding traffic information from a source vehicle travelling on a road at a light signal device in a light signal network;
storing the traffic information encoded in the vehicle light signals to form stored traffic information; and
transmitting transmission light signals encoding the stored traffic information from the light signal network to a receiver vehicle in response to detecting the receiver vehicle traveling along the road.

11. The computer system of claim 10, wherein said storing the traffic information comprises:
processing the traffic information to determine traffic conditions relating to the road; and
storing the traffic conditions to form the stored traffic information.

12. The computer system of claim 10, wherein said transmitting the transmission light signals comprises:
transmitting the transmission light signals encoding the stored traffic information from the light signal device in response to the light signal device detecting the receiver vehicle traveling on the road.

13. The computer system of claim 10, wherein said transmitting transmitted light signals comprises:
transmitting the transmission light signals encoding the stored traffic information from another light signal device along the road in response to the another light signal device detecting the receiver vehicle traveling on the road.

14. The computer system of claim 10, wherein the stored traffic information is for a selected traffic condition and further comprising:
updating the stored traffic information in response to receiving updated traffic information for the selected traffic condition.

15. The computer system of claim 10, wherein the stored traffic information is for a selected traffic condition and further comprising:
identifying an expiration time for the selected traffic condition; and
discarding the stored traffic information for the selected traffic condition in response to an absence of receiving an update to the stored traffic information for the selected traffic condition within the expiration time.

16. The computer system of claim 10 further comprising:
transmitting the stored traffic information from the light signal device to a second light signal device that is located along the road upstream from the light signal device; and
transmitting the stored traffic information in the transmission light signals encoding the stored traffic information from the second light signal device to a second receiver vehicle in response to the second light signal device detecting the second receiver vehicle on the road.

17. The computer system of claim 10, wherein the light signal device is connected to a platform selected from a group comprising a road light, a light signal, a road sign.

18. The computer system of claim 10, wherein the light signal network is selected from a group comprising a LiFi network and an optical network.

19. A computer program product for vehicle to vehicle communications, the computer program product comprising:
a set of one or more computer-readable storage media;
program instructions stored on the set of one or more storage media to perform operations comprising:
receiving vehicle light signals encoding traffic information from a source vehicle travelling on a road at a light signal device in a light signal network;
storing the traffic information encoded in the vehicle light signals to form stored traffic information; and
transmitting transmission light signals encoding the stored traffic information from the light signal network to a receiver vehicle in response to detecting the receiver vehicle traveling along the road.

20. The computer program product of claim 19, wherein said storing the traffic information comprises:
processing the traffic information to determine traffic conditions relating to the road; and
storing the traffic conditions to form the stored traffic information.
